(19) United States
(12) Patent Application Publication
(10) Pub. No.: US 2026/0324527 A1
(43) Pub. Date: Oct. 22, 2026

(54) METHOD AND APPARATUS FOR SMOOTHING SOIL

(71) Applicant: Tillage Management Incorporated, Tulare, CA (US)

(72) Inventor: Samuel C. Hoffman, Tulare, CA (US)

(73) Assignee: Tillage Management Incorporated, Tulare, CA (US)

(21) Appl. No.: 19/184,621

(22) Filed: Apr. 21, 2025

(51) Int. Cl. A01B 31/00; A01B 63/24

(52) U.S. Cl. CPC A01B 31/00; A01B 63/24

(57) ABSTRACT

A drag scraper is mounted to a rear end of an agricultural implement. A blade plate extends outward beyond a side plane of the agricultural implement to level any unlevel soil that remains after an action, such as tillage, by the implement. The blade plate can move relative to axes of rotation. The blade plate can rotate or pivot about a horizontal axis and vertical axis. There are various stops on the drag scraper that bound the rotational path of travel about each of the axes. The hinges that define the axes may be hinges that bias the blade plate or other components of the drag scraper back to a neutral position after pivoting in response to drag scraper contact with an object or uneven soil.

### TECHNICAL FIELD

This disclosure is directed to a component of an agricultural implement that is pulled by a tractor.

### BACKGROUND ART

Agricultural implements are often pulled by tractors to manipulate soil. Many implements can break up and mix the soil, improving aeration and allowing better root penetration. Various implements may help in uprooting weeds, reducing competition for nutrients and water. Implements may also break down crop residues, incorporating them into the soil, which can enhance soil organic matter. Agricultural implements can also create a uniform seedbed, thereby promoting uniform seed germination and faster crop emergence.

However, one issue with using these implements is that they can leave the soil surface uneven. This unevenness can lead to problems such as inconsistent crop growth due to uneven soil leading to inconsistent seed-to-soil contact, affecting crop emergence and growth. Additionally, uneven soil can cause water to pool in certain areas, leading to waterlogging and poor drainage in others. Still further, uneven surfaces are more prone to erosion by wind and water, which can result in the loss of topsoil.

### SUMMARY OF THE INVENTION

Having recognized that a need continues to level a soil surface after an agricultural implement has utilized, the present disclosure provides various embodiments and methods of a drag scraper that can be connected to a rear end of an agricultural implement. More particularly, some aspects of the present disclosure may provide a drag scraper that is mounted to a rear end of an agricultural implement. A blade plate extends outward beyond a side plane of the agricultural implement to level any unlevel soil that remains after an action, such as tillage, by the implement. The blade plate can move or pivot relative to at least two axes of rotation. The blade plate of the drag scraper can rotate or pivot about a horizontal axis and vertical axis. There are various stops on the drag scraper that bound the rotational path of travel about each of the axes. The hinges that define the axes may be hinges that bias the blade plate or other components of the drag scraper back to a neutral position after pivoting in response to drag scraper contact with an object or uneven soil.

In one aspect, an exemplary embodiment of the present disclosure may provide a drag scraper for connection with a rear end of an agricultural implement, wherein the drag scraper is configured to smooth soil as the agricultural implement is pulled, and the drag scraper comprising: a first hinge defining a first pivot axis, wherein the first axis is oriented in a vertical direction; a second hinge defining a second pivot axis, wherein the second axis is oriented in a horizontal direction; a blade plate positioned rearward of the first hinge and the second hinge, wherein the blade pivots about the first axis in response to contact with an object located outward from a first side of the agricultural implement to which the drag scraper is mounted, and wherein the blade pivots about the second axis in response to contact with unlevel soil in response to lowering of the agricultural implement to which the drag scraper is attached. This exemplary embodiment or another exemplary embodiment may include a rebound position of the blade plate; a jounce position of the blade plate; and wherein the blade plate moves from the rebound position to the jounce position based on surface contours of the soil or a height of the agricultural implement, wherein the blade plate pivots about the second pivot axis, moving between the jounce and rebound positions relative to the ground or upon contact with an object in the soil, wherein a bottom edge of the blade plate is parallel and maintains a consistent level relative to ground when pulled by the agricultural implement through or across soil. This exemplary embodiment or another exemplary embodiment of the present disclosure may include a first pivot arm having a first end and a second end, wherein the first end of the pivot arm is coupled to the first hinge and the second end of the first pivot arm is coupled to the second hinge. This exemplary embodiment or another exemplary embodiment of the present disclosure may include a second pivot arm having a forward end and a rear end, wherein the forward end of the second pivot arm is coupled to the second hinge and the rear end of the second pivot arm is connected to the blade plate. This exemplary embodiment or another exemplary embodiment of the present disclosure may include a first stop and a second stop at the first end of the first pivot arm, wherein the first stop and the second stop bound a rotational path of travel about the first pivot axis; and a third stop and a fourth stop at the forward end of the second pivot arm, wherein the third stop and the fourth stop bound a rotational path of travel about the second pivot axis. This exemplary embodiment or another exemplary embodiment of the present disclosure may include a length of the of the blade plate measure from an outer end to an inner end, wherein the length of the blade plate is greater than that of the first pivot arm. This exemplary embodiment or another exemplary embodiment of the present disclosure may include an outer end of the blade plate and an inner end of the blade plate, wherein when the drag scraper is in a neutral position the outer end of the blade plate is positioned outward from a first side plane defined by an outermost side of the agricultural implement. This exemplary embodiment or another exemplary embodiment of the present disclosure may include a forward surface and a rear surface of the blade plate; and a neutral position of the blade plate, wherein the forward surface of the blade plate is in a range from about 30 degrees to about 60 degrees relative to horizontal in the neutral position. This exemplary embodiment or another exemplary embodiment of the present disclosure may include a first stop at an end of a first pivot arm; a second stop at the end of the first pivot arm, wherein the first stop and the second stop bound a rotational path of travel about the first pivot axis; wherein the rotational path of travel is bounded in a region of about 30 degrees about the first pivot axis. This exemplary embodiment or another exemplary embodiment of the present disclosure may include a mounting plate for mounting the drag scraper to the agricultural implement, wherein the mounting plate has a forward end and a rear end; wherein the first hinge is coupled the mounting plate near the rear end of the mounting plate; a first pivot arm coupled to the first hinge and extending therefrom; an angle defined between the first pivot arm and the mounting plate; a neutral position of the first pivot arm and rotated position of the first pivot arm, wherein the first pivot arm moves from the neutral position to the rotated position in response to contact from an object as the agricultural implement and drag scraper are pulled forward; wherein the angle is about 120 degrees in the neutral position and wherein the angle is about 90 degrees in the rotated position. This exemplary embodiment or another exemplary embodiment of the present disclosure may include a mounting plate for mounting the drag scraper to the agricultural implement, wherein the mounting plate has a forward end and a rear end; wherein the first hinge is coupled the mounting plate near the rear end of the mounting plate; a first pivot arm coupled to the first hinge and extending therefrom; wherein the second hinge is coupled to first pivot arm along a bottom edge thereof; two second pivot arms coupled to the second hinge, wherein one of the second pivot arms is coupled to a first end of the second hinge and the other of the second pivot arms is coupled to a second end of the second hinge; a rear end of each of the two second pivot arms that is coupled to a forward surface of the blade plate. This exemplary embodiment or another exemplary embodiment of the present disclosure may include a first rotational action of the blade plate about the first axis that occurs within an about 30 degree bounded path travel, wherein the first rotational action is bounded between a first stop and a second stop; a second rotational action of the blade plate about the second axis, wherein the second rotational action is bounded between a third stop and a fourth stop; wherein the first axis is perpendicular to the second axis.

In another aspect, an exemplary embodiment of the present disclosure may provide a drag scraper for connection with a rear end of an agricultural implement, wherein the drag scraper is configured to smooth soil as the agricultural implement is pulled, and the drag scraper comprising: a mounting plate having a forward end and a rear end, wherein the mounting plate defines at least one aperture extending through the mounting plate to connect the mounting plate to the rear end of the agricultural implement, wherein the mounting plate has first major surface that faces outward relative to the agricultural implement and a second major surface that faces inward relative to the agricultural implement; a first hinge connected to the second major surface of the mounting plate, wherein the first hinge defines a first pivot axis that is aligned in a vertical direction; a first pivot arm having a first end and a second end, wherein the first end of the first pivot arm is connected to the first hinge and the first pivot arm pivots about the first pivot axis, wherein a first stop and a second stop are connected to the first end of the first pivot arm, wherein the first stop and the second stop bound a rotational path of travel of the first pivot arm about the first pivot axis; a second hinge connected to the first pivot arm near the second end of the first pivot arm, wherein the second hinge defines a second pivot axis that is aligned in a horizontal direction; a second pivot arm having a forward end and a rear end, wherein the forward end of the second pivot arm is connected to the second hinge and the second pivot arm pivots about the second pivot axis, wherein a third stop and a fourth stop are connected to the forward end of the second pivot arm, wherein the third stop and the fourth stop bound a rotational path of travel of the second pivot arm about the second pivot axis; and a blade plate having a forward surface and a rear surface, and having a top end and bottom end, wherein the blade plate is rigidly connected to the rear end of the second pivot arm, wherein the bottom end of the blade plate smooths soil and pivots about the first pivot axis and the second pivot axis in response to interaction with the soil as the agricultural implement is pulled.

In yet another aspect, an exemplary embodiment of the present disclosure may provide a method comprising: coupling a drag scraper to a first side of an agricultural implement at a rear end thereof; orienting a blade plate in a neutral position and positioning an outer end of the blade plate outward from a first side plane of the agricultural implement; pulling the agricultural implement forward; rotating the blade plate about a first pivot axis that is vertically aligned in response to making contact with an object located outward from the first side plane from the agricultural implement; rotating the blade plate about a second pivot axis that is horizontally aligned in response to making contact with unlevel soil; leveling the soil behind the agricultural implement with the drag scraper. This exemplary embodiment or another exemplary embodiment of the present disclosure may include rotating a first pivot arm about the first pivot axis from a neutral first position to a second position, wherein a first stop on the first pivot arm contacts an inner surface of a mounting plate coupled to the agricultural implement; and bounding rotation of the first pivot arm at the second position. This exemplary embodiment or another exemplary embodiment of the present disclosure may provide that bounding rotation of the first pivot arm is accomplished by contacting a second stop on the first pivot arm with the inner surface of the mounting plate. This exemplary embodiment or another exemplary embodiment of the present disclosure may include rotating a second pivot arm about the second pivot axis from the neutral first position to either one of a jounce position or a rebound position, wherein a third stop on the second pivot arm contacts a forward surface on the first pivot arm in the rebound position and fourth stop on the second pivot arm contacts a rear surface on the first pivot arm in the jounce position; and bounding rotation of the second pivot arm between the rebound position via the third stop and the jounce position via the fourth stop.

### BRIEF DESCRIPTION OF THE DRAWINGS

One or more exemplary embodiment(s) of the present disclosure is set forth in the following description, is shown in the drawings and is particularly and distinctly pointed out and set forth in the appended claims. The accompanying drawings, which are incorporated in and constitute a part of the specification, illustrate various example configurations and methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a top rear perspective view of an exemplary agricultural implement.

FIG. 2 is a top plan view of the rear end of another exemplary agricultural implement having a two drag scrapers connected thereto according to an exemplary aspect of the present disclosure.

FIG. 3 is a top rear perspective view of one exemplary drag scraper.

FIG. 4 is a top plan view of the exemplary drag scraper.

FIG. 5A is an inner side elevation view of the drag scraper in the neutral position.

FIG. 5B is an inner side elevation view of the drag scraper in the raised or jounce position after pivoting or rotating relative to a horizontal axis.

FIG. 5C is an inner side elevation view of the drag scraper in the lowered or rebound position after pivoting or rotating relative to the horizontal axis.

FIG. 6 is a top plan view of the drag scraper in a second position after pivoting or rotating about a vertical axis.

Similar numbers refer to similar parts throughout the drawings.

### DETAILED DESCRIPTION

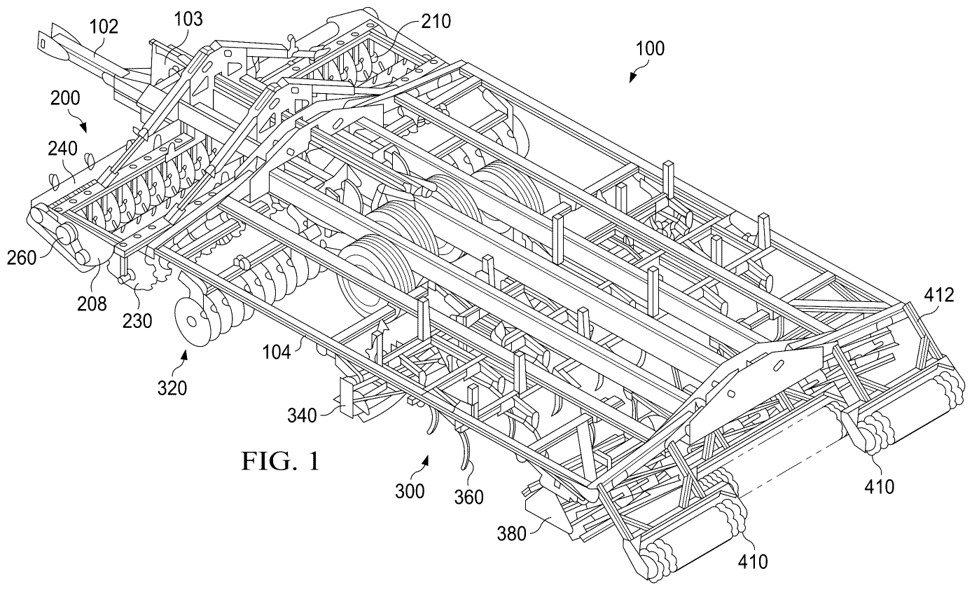

FIG. 1 depicts a farm implement generally at 100. The farm implement 100 has a hitch portion 102 and a rigid frame 104. The frame 104 may be made out of hollow steel beams with rectangular cross sections. The hitch portion 102 may be pivotally attached to the frame 104 near a tongue 103. The forward portion of the hitch portion 102 is attachable to the hitching structure of a tractor or other vehicle (not shown) for pulling the farm implement 100 across ground or soil along a direction of travel.

The frame 104 comprises a central frame structure to support the components of the implement detailed herein. Although not shown in the figures, the frame 104 may carry a fertilizer or herbicide tank and fertilizer spraying equipment. The frame 104 may also carry a planter hopper with feed distribution capability. Thus, spraying equipment can be disposed before or after any of the cultivating devices connected to the frame 104.

The frame 104 may include a front folding frame assembly 200 comprising left and right front frame wings, and a rear folding frame assembly 300 comprising left and right rear frame wings. The left and right front frame wings are located on opposite sides of a central frame structure. Each of the front frame wings comprises lateral wing beams (or members) having one end portion coupled to the central frame structure and the other end portion distal to the central frame structure. Crossbeams may connect the lateral wing beams at their ends. Laterally spaced end panels 208 are positioned outside of the crossbeams.

Supported by the front folding frame assembly 200 are left and right compacted soil breaking and loosening mechanisms 210. Each of the mechanisms 210 is preferable a disc/drive unit 210 comprising a row of first discs, a row of second discs 230, a ground-engaging driver 240, and a driven flow controller.

For each of the disc/drive units 210, the first discs are coupled to the respective one of the front frame wings and arranged in a first row, which as illustrated is preferably substantially perpendicular to the direction of travel. The second discs 230 are also coupled to the front frame wings, and are arranged in a second row, which is behind the row of first discs and is substantially perpendicular to the direction of travel. Preferably, the first row and second row of discs are each linear, with the second row of discs 230 behind and parallel to the first row of discs.

Each of the disc/drive units 210 may have a respective ground-engaging driver 240 coupled to the front frame wings and positioned ahead of the plurality of first discs relative to the direction of travel. In one exemplary embodiment, each ground-engaging driver 240 may comprise a respective driver shaft extending laterally across the width of the farm implement 100.

For each of the units 210, the ground-engaging driver 240 operatively controls the rotational speed of a driven flow controller with an accelerator unit 260. The accelerator unit 260 is set on a platform 261 adjacent one of the end panels. The accelerator unit 260 comprises a sprocket positioned on one end of the driver shaft and another sprocket is positioned on one end of the driven shaft. It should be understood that the accelerator unit 260 may possess different structures and arrangements that those illustrated and described above.

The disc/drive units 210 are most useful for primary tillage, although also useful for secondary and deep tillage. The disc/drive units 210 are preferably detachable and re-attachable to the frame 104 for allowing alternative compacted soil and breaking mechanisms, such as secondary tillage mechanisms, to be attached to the frame 104.

As mentioned above, the rear folding frame assembly 300 comprises left and right rear frame wings. The left and right rear frame wings are located on opposite sides of the central frame structure. Each of the rear frame wings comprises lateral wing beams (or members) having one end portion pivotally coupled to the central frame structure and the other end portion distal to the central frame structure. Outer longitudinal beams connect the lateral wing beams at their distal ends. Inner longitudinal beams connect the lateral wing beams, but are positioned between the central frame structure and the outer longitudinal beams 306.

Positioned to the rear of the mechanism 210 are left and right coulter assemblies 320, each of which is coupled to crossbeam row. Each of the coulter assemblies 320 may comprises a coulter shaft with an axis substantially perpendicular to the direction of travel. A plurality of coulter blades (or discs) are annular in shape to snugly fit over the coulter shaft. The coulter blades are spaced axially relative to each other along the axis of the coulter shaft. Each of the coulter blades has a ground-engaging outer periphery. Although not shown, the peripheries of the coulter blades may have notches extending radially inward, as is known in the art. The coulter blades may also be fluted.

The ends of the coulter shaft are rotationally coupled to coulter side weldments by an appropriate bearing arrangement or the like. A coulter cross member extends between the coulter side weldments to maintain the spacing between the side weldments and provide structural support to the coulter assembly. The upper portion of the coulter side weldment includes a channel receiving an end portion of a coulter swing arm. Fingers extend over the coulter swing arm to hold it in place, and a coulter lock pin prevents longitudinal movement of the coulter swing arm relative to the channel of the coulter side weldment. The other end of the coulter swing arm is pivotally connected to the crossbeam row by a suitable pivot-pin arrangement. Located on top of the coulter cross member is a coulter pivot pin assembly. A coulter assembly load-adjusting actuator, such as a hydraulic or pneumatic cylinder or other biasing device, has one end coupled to the coulter pivot pin assembly. The other end of the coulter assembly load-adjusting actuator is connected to the frame 104, such as the inner longitudinal beam. The end connections of the coulter assembly load-adjusting actuator are preferably pivot-pin arrangements, which preferably have spherical bearings.

Chopping and breaking reel assemblies, or “mid-reel” assemblies 340 are coupled to frame 104. The reel assemblies 340 are preferably of the type commercially available under the name “DO-ALL” manufactured by Forrest City Machine Works, Inc. of Forrest City, Ark. Each reel assembly 340 has a reel shaft and blades attached to the outer peripheral surface of the reel shaft via attaching members. The attaching members are preferably welded to a peripheral surface of the reel shaft and the blades are preferably bolted to the attaching members. The blades have ground engaging edges. The blades are pitched or angled with respect to the longitudinal axis of the reel shaft when attached to the attaching members. This pitch is caused by circumferentially offsetting adjacent sets of attaching members such that when the blades are attached thereto, the blades are twisted about their longitudinal axis and pitched with respect to the longitudinal axis of the reel shaft. Generally, the blades lie along a helical pattern.

The working of the soil by the soil breaking and loosing mechanisms 210 and the coulter blades allows the reel assemblies 340 to operate at maximum performance to chop stubble or other debris and to break clods while mixing the loosened soil. The reel assemblies 340 perform this action by rotating as the implement 100 is pulled through the soil such that the edges of the blades perform the chopping and breaking function. To enhance this function, the blades may be radially offset (or slanted) forward by an angle of 10 to 12 degrees.

Chisel shanks (or tines) 360 may be attached to crossbeam rows of frame 104. Each row of shanks 360 is offset in the lateral direction from its adjacent row or rows of shanks 360. Each shank 360 in each row is spaced from adjacent shank. As referred to herein, chisel shanks 360 also mean blades capable of penetrating into the earth, including those having a sweep or tooth (not shown) disposed on its lower end to engage the ground.

One or more basket units 380 are positioned across, near the rear of the implement 100. Each basket unit 380 has a movable or swingable support structure. The structure has end panels that are connected by a top horizontal beam. A tilt-adjustment member is mounted on the horizontal beam. The tilt adjustment member has a plurality of apertures each of which can receive a lock pin. The tilt-adjustment member is pivotally coupled to suspension beam by a pivot-pin arrangement and lock pin (not shown) placed through one of the apertures and an aperture (not shown) in the suspension beam. The upper end of the suspension beam is pivotally connected to the rear frame wing by a suitable pivot-pin arrangement. The apertures and pivot-pin arrangement may be situated elsewhere. For example, apertures may be placed more toward the forward end of the tilt-adjusting member.

Each basket unit 380 has a forward roller with a shaft and a rearward roller with a shaft. The shafts are rotatably supported between the panels. Any suitable bearing arrangement may be used to support the shafts on the panels. Each of the basket units 380 has an adjusting arrangement for adjusting the amount of force that the rollers apply to the soil. Each adjusting arrangement comprises a basket unit load-adjusting actuator, such as a hydraulic or pneumatic cylinder or the like. The basket unit load-adjusting actuator is, connected at its lower end to a connecting flange on one of the horizontal beams by a suitable pivot-pin arrangement. The upper end of the basket unit load-adjusting actuator is likewise attached by a suitable pivot-pin arrangement to the frame 104, such as the inner longitudinal beam. Thus, as the load-adjusting actuator is pressurized, the rollers are lowered towards the soil. As is apparent, the cylinders can be used to apply variable pressure to the soil through the rollers and to thus obtain the desired soil condition of a seedbed.

In the event that the load-adjusting actuators described above are hydraulic cylinders, the cylinders can be hooked up to the hydraulic system of the tractor and can thus be adjusted by the machine operator even when the implement is being pulled through the soil. By individually controlling the respective loads of the various components of the implement 100, the operator can distribute weight evenly throughout the cultivating devices of the implement 100 to minimize compaction and attain desired tillage effects. Each basket unit 380 can have a tilt adjusting capability.

Finishing rollers 410 can be located behind the rear roller of the basket unit 380. Support frames 412 rotatably supports the finishing rollers 410. Each of the support frames extends from and is connected to the rearwardmost of beams of the frame 104. The finishing rollers 410 may be solid rollers or floating rings, optionally having notches disposed circumferentially along its peripheral surface and extending radially inward. The finishing rollers 410 serve to further break down any remaining dirt clods and serves to seal moisture into the ground.

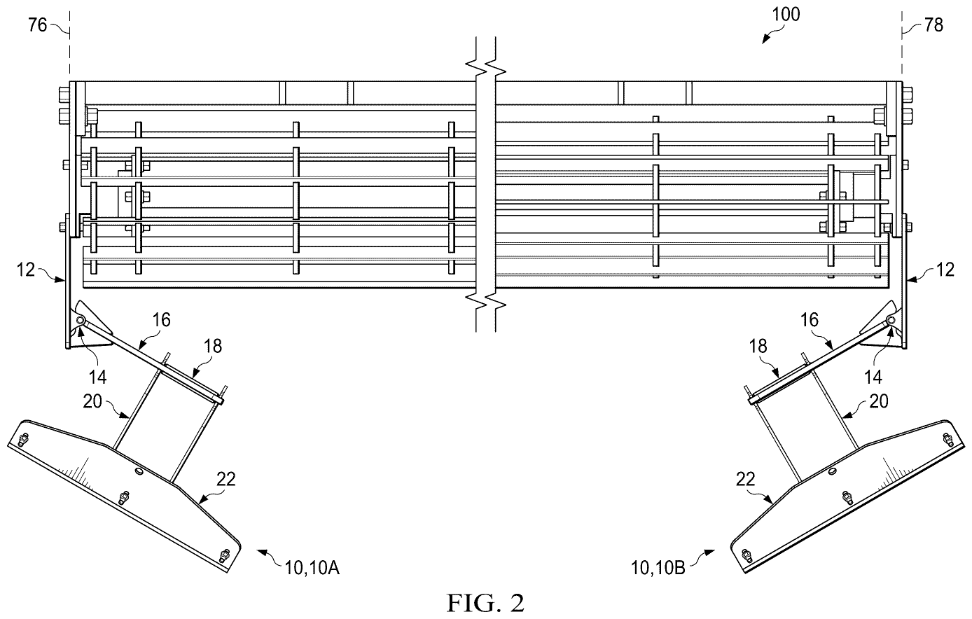

Having thus described the implement 100, in general, reference is now made to another component that can be added to the implement 100 for further soil smoothing, leveling or manipulation. This other component can generally be considered to be a drag scraper, which is shown generally throughout FIG. 2-FIG. 6. Furthermore, while the drag scraper is shown as being attachable to implement 100, it is to be understood that the drag scraper shown herein could be utilized with any type of agricultural implement that needs to smooth, alter or manipulate the ground/soil, not just implement 100, which has been shown for exemplary purposes. For example, the rear end of implement 100 shown in FIG. 2 is different than the implement 100 shown in FIG. 1. This identifies that the additional component (i.e., drag scraper 10, discussed below) that can be added to the implement 100 can connect to the rear of any type of agricultural implement.

FIG. 2 depict a drag scraper generally at 10. Drag scraper 10 is configured to smooth or level soil or dirt as the implement 100 is pulled through an agricultural field. Further, it is envisioned that there will be a drag scraper 10 located on each side of the implement 100 at the rear end thereof. As such, FIG. 2 depicts a first drag scraper 10A located on the first side of the implement 100 at the rear end thereof and a second drag scraper 10B located on the second side of the implement 100 at the rear end thereof. It is further to be understood that the first drag scraper 10A and the second drag scraper 10B are configured as mirrored opposites of each other. Thus, for brevity, some of the description below relating to the first drag scraper 10A on the first side of the implement 100 is to be understood to also apply to the second drag scraper 10B on the second side of the implement 100.

Each drag scraper 10 is configured, sized and/or shaped for connection with a rear end of the agricultural implement 100, wherein the drag scraper 10 is configured to smooth soil as the agricultural implement 100 is pulled. The drag scraper may include a mounting plate 12, a first hinge 14, a first pivot arm 16, a second hinge 18, a second pivot arm 20, and a blade plate 22.

With continued reference to FIG. 2, it is seen that the rear end of the agricultural implement 100 can have any useful tool that one having ordinary skill in the art with agricultural implements would understand. Thus, while FIG. 1 indicates that the rearmost elements of the agricultural implement 100 is the rollers 410, the agricultural implement 100 shown in FIG. 2 utilizes a different style tool such as a paddle wheel. Regardless of the type of implement that defines the rear end of the agricultural implement 100, the drag scrapers 10A, 10B are configured to mount to the frame of the agricultural implement 100 along the sides thereof. For example, as shown in FIG. 2, the first drag scraper 10A is mounted to the first side of the frame at the rear end of the agricultural implement 100 and the second drag scraper 10B is mounted to the second side of the frame of the agricultural implement 100 and the drag scrapers 10A, 10B extend rearwardly therefrom. Notably, the first side of the agricultural implement defines a first side plane 76 and the second side of the agricultural implement 100 defines a second side plane 78. A portion of the drag scrapers extend outboard or outwardly beyond these respective planes 76, 78. Namely, the outer ends of the blade plate 22 are positioned outboard or outward from the respective side plane 76, 78. As such, the pair of drag scrapers 10A, 10B will define the maximum width of the agricultural implement 100 when they are attached to the rear end thereof. The purpose of utilizing the drag scrapers 10A, 10B as the maximum width is to allow soil to be smoothed that is tilled by the agricultural implement 100 so as to not leave a soil ridge in the ground that is common at the outer edge or outer sides of the implement 100.

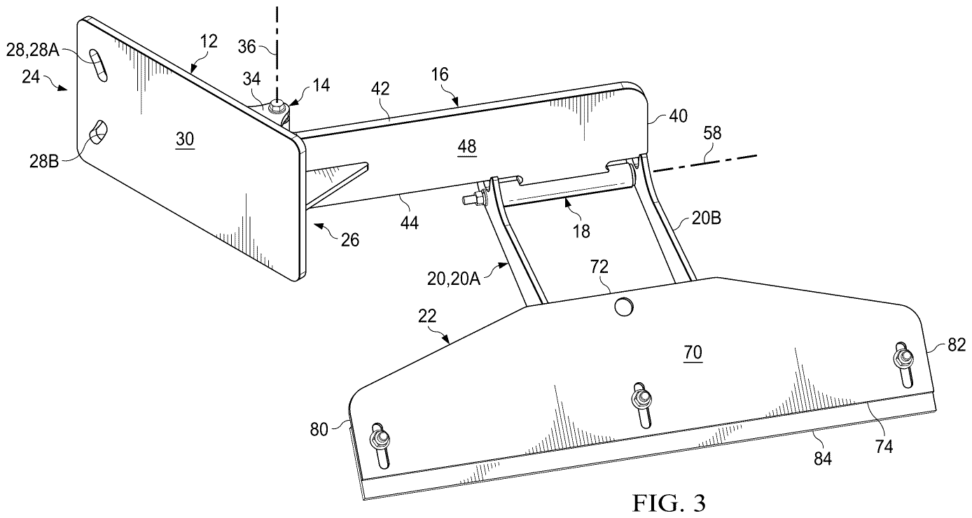

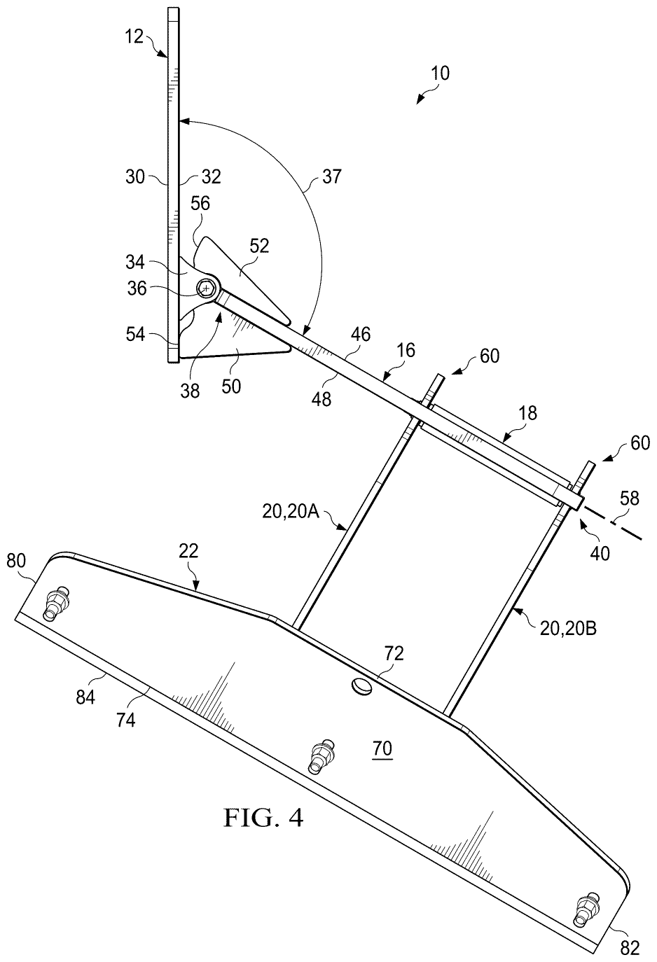

FIG. 3 and FIG. 4 depict that the mounting plate 12 has a forward end 24 and a rear end 26. The mounting plate 12 defines at least one aperture 28 extending laterally through the mounting plate 12 to connect the mounting plate to the rear end of the agricultural implement 100, wherein the mounting plate has first major surface 30 that faces outward relative to the agricultural implement 100 and a second major surface 32 that faces inward relative to the agricultural implement 100. The connection may be accomplished via a bolt that extends through the aperture 28 to attach the mounting plate 12 of the drag scraper 10 to an exterior side surface at the rear end of the implement 100.

In one exemplary embodiment, the mounting plate 12 is shaped as a rigid metal rectangular plate having rounded corners, wherein the length of the plate 12 is greater than its heigh, and the length of plate 12 is oriented parallel to the forward direction of travel of the agricultural implement 100. The thickness of the plate 12 may be defined by the distance between the first major surface 30 and the second major surface 32. In one embodiment, the thickness of the plate 12 is uniform between the forward end 24 and the rear end 26. However, it could be possible for the plate to have a non-uniform thickness between ends 24, 26 of plate 12. The forward end 24 is oriented forward from rear end 26. The at least one aperture 28 is oriented or defined close to the forward end 24 of the mounting plate 12. In the shown embodiment, the at least one aperture 28 is defined closer to the forward end 24 than the rear end 26 of the mounting plate. In one particular embodiment, there are two apertures 28A, 28B formed near the forward end of the plate 12. The two apertures 28A, 28B enable the mounting plate to be connected to the rear end of implement 100. The two apertures 28A, 28B may be formed as slots that are angled at about 45 degree angles relative to horizontal to allow the mounting plate 12 to be connected or mounted to the rear end of the implement 100 and level relative to horizontal.

In one exemplary embodiment, there may be a pair of flanges 34 that are connected to the second major surface 32. The flanges 34 extend from the second major surface 32 in the direction toward the centerline of the implement 100. The flanges are utilized to couple the first hinge 14 to the second major surface 32 of the mounting plate. In the shown embodiment, the flanges 34 are positioned in a spaced-apart vertical arrangement such that a first flange is located above a second flange. The pair of flanges 34 are positioned closer to the rear end 26 of the mounting plate 12 than forward end 24 of the mounting plate 12. The flanges 34 are rigid members having a widened base directly and rigidly connected to the second major surface 32. The flanges 34 may have a rounded end or tip spaced apart from the second major surface 32.

The first hinge 14 is coupled to the second major surface 32 of the mounting plate 12 via the flanges 34. The first hinge 14 includes a rigid cylindrical body that extends vertically between the flanges 34. The hinge 14 enables the first pivot arm 16 to pivot in both directions about a first pivot axis 36 defined by the first hinge 14. In the shown embodiment, the axis 36 is aligned in a vertical direction. The axis 36 is positioned inwardly (i.e., towards the longitudinal centerline of the implement 100) from the side plane 76. A similar arrangement for the second scraper 10B positions its axis 36 inwardly from the second side plane 78. The first hinge 14 is mounted in a manner that positions the blade plate 22 in a neutral position when the first pivot arm 16 is connected to the mounting plate 12. This arrangement enables the hinge 14 to rotate about axis 36 in either direction, wherein the hinge 14 is configured to enable the first pivot arm to return to its neutral position when an object in the ground that has contacted the blade 22 has been passed. The neutral position is that which is shown in FIG. 2. When the first pivot arm 16 is in the neutral position, an angle 37 is defined between the length of the first pivot arm 16 and the length of the of the mounting plate 12. In one exemplary embodiment, the angle 37 is greater than 90 degrees but less than 180 degrees. In the shown particular example, the angle 37 is about 120 degrees. Similarly, in the neutral position the length of the blade plate is oriented at an angle of about 30 degrees relative to a lateral axis that extends perpendicular to planes 76, 78. In one particular embodiment, the hinge 14 does not include a spring and simply a free swing hinge. Namely, the configuration of the scraper 10 which uses a vertical pivot axis 36 defined by hinge 14 that is offset from the center of the blade 22 allows the blade 22 to return to its neutral or working position without the use of springs after a portion of the blade 22 has contacted the object in the ground. Additionally, by positioning axis 36 of hinge 14 inwardly from the first side plane 76 allows the blade 22 to retract or pivot if the blade 22 contacts the first end 80 of the blade, wherein the first end 80 of the blade is dispose outward or outboard from the first side plane 76.

The first pivot arm 16 includes a first end 38 and a second end 40. The first end 38 of the first pivot arm 16 is connected to the first hinge 14 and the first pivot arm 16 pivots about the first pivot axis 36. The first pivot arm includes a top edge 42 and a bottom edge 44. First pivot arm 16 may be formed as a rigid member, such as a plate or a bar, having a forward surface 46 and a rear surface 48. The length of the first pivot arm 16 (i.e., measured from first end 38 to second end 40) may be greater than the height (i.e., measured from the top edge 42 to the bottom edge 44). The body of the first pivot arm 16 extends outward from the first hinge 14 in a cantilevered manner.

On the first pivot arm 16, there is a first stop 50 and a second stop 52. The first stop 50 and the second stop 52 cooperate to bound a rotational path of travel of the first pivot arm 16 (and therefore the blade plate 22) about the first pivot axis 36. The first stop 50 is mounted on the rear surface 48 at the first end 38. The first stop 50 may be mounted or rigidly connected to the rear surface 48 approximately halfway between the top edge 42 and the bottom edge 44. The first stop 50 may be shaped as a generally triangular plate formed of rigid material. There may be a stop surface 54 on first stop 50 that is configured to engage and contact the second surface 32 of the mounting plate 12. The second stop 52 is mounted on the forward surface 46 at the first end 38. The second stop 52 may be mounted or rigidly connected to the front surface 46 approximately halfway between the top edge 42 and the bottom edge 44. The second stop 52 may be shaped as a generally triangular plate formed of rigid material. There may be a stop surface 56 on second stop 52 that is configured to engage and contact the second surface 32 of the mounting plate when the first arm 16 pivots about axis 36.

The second hinge 18 is connected to the first pivot arm 16 near the second end 40 of the first pivot arm 16. The second hinge 18 includes a rigid cylindrical body that extends horizontally and parallel to the length of the first pivot arm 16. The hinge 18 enables the second pivot arm 20 to rotate about a second pivot axis 58 defined by the second hinge 18. In the shown embodiment, the second pivot axis 58 is aligned in a horizontal direction and is oriented at an angle of about 30 degrees relative to a lateral axis that extends perpendicular to planes 76, 78. The second hinge 18 is mounted in a manner that positions the arm 20 in a neutral position when the second pivot arm 20 is connected near or to the second end 40 of the first pivot arm 16 and neither stop on the end of the second pivot arm is contacting either the forward surface 46 or the rear surface 48 of the first pivot arm 16. This arrangement enables the hinge 18 to rotate about axis 58 in either direction, wherein the second pivot arm 20 returns to its neutral position when the object that has contacted the blade plate 22 has been passed. The neutral position is that which is shown in FIG. 2. In the shown example, the cylindrical body of second hinge 18 is connected directly to the bottom edge 44 of the first pivot arm 16 near the second end 40 thereof. However, it is to be understood that the second pivot hinge 18 could be located at an alternative location on the first pivot arm 16.

The second pivot arm 20 may be one of a pair of second pivot arms. In the shown example, each of the two second pivot arms 20 is identical to each other and spaced apart from each other by a distance equal to the length dimension of the cylindrical body of the second hinge 18. Thus, there may be second pivot arm 20A and second pivot arm 20B as shown in FIG. 3.

Each second pivot arm 20 (i.e., arm 20A and arm 20B) may have a forward end 60 and a rear end 62. Each pivot arm may define an aperture near the forward end 60 thereof that receives a screw or bolt therethrough to connect the second pivot arm 20 with the second hinge 18. Wherein the screw that connects the second pivot arm 20 may be coaxial along second pivot axis 58 or offset parallel to and below the pivot axis 58. As such, the forward end 60 of the second pivot arm 20 is connected to the second hinge 18 such that the second pivot arm 20 is able to pivot about the second pivot axis 58 in response to the blade plate 22 contacting an object in the ground as the scraper 10 is pulled forward by the implement 100. Each second pivot arm 20 has a third stop 64 and a fourth stop 66 that are connected to or otherwise formed in the forward end 60 of the second pivot arm 20. The third stop 64 and the fourth stop 66 bound a rotational path of travel of the second pivot arm 20 about the second pivot axis 58. In one particular embodiment, the rearward extension of the pivot arm 20 from the hinge 18 creates a lever arm or moment arm from the rotation about axis 18 that is bounded by third stop 64. This configuration utilizes gravitational force and the mass of the blade plate 22 and the second pivot arm 20 to maintain a consistent level of the blade edge or insert 84 as the scraper 10 is pulled forward by the implement. However, if the blade plate 22 or the insert 84 contacts an object in the ground, then the blade plate 22 may pivot upward about axis 58 defined by hinge 18 to pass by the object.

The second pivot arm 20 defines the third stop 64 and the fourth stop 66 at the forward end 60. In the shown embodiment, the stops 64, 66 are integrally formed with the body of the second pivot arm 20. Each of the stops 64, 66 project upwardly in the vertical direction to define a U-shaped edge 88. The screw or bolt that connects the arm 20 to the second hinge 18 is positioned below the U-shaped edge 88. The U-shaped edge 88 is positioned and is configured to receive the bottom edge 44 of the first pivot arm 16 therein. This allows the third stop 64 to be positioned forwardly of the forward surface 46 on the first pivot arm 16 and the fourth stop 66 to be positioned rearward of the rear surface 48 of the first pivot arm 16. As stated previously, the second pivot arm 20 is configured to pivot about the second pivot axis 58 in response to soil contacting the blade plate 22 or the blade insert 84 during operational movement of the agricultural implement 100 as it is pulled forward.

The blade plate 22 has a forward surface 68 and a rear surface 70, and has a top end 72 and bottom end 74. The blade plate 22 is rigidly connected to the rear end 62 of the second pivot arm 20. The bottom end 74 or a sacrificial bar or insert 84 connected to the bottom end 74 of the blade plate 22 smooths soil and pivots about the first pivot axis 36 and the second pivot axis 58 in response to interaction with the soil as the agricultural implement 100 is pulled. Blade plate 22 may have a rigid planar body. It can be generally shaped as a rectangular plate having truncated top corners that establishes a downwardly slanted top edge on each side of the blade plate 22.

With continued reference to the blade plate 22, the blade plate 22 includes an outer edge 80 and an inner edge 82. The outer edge 80 of the blade plate 22 is positioned outward from the first surface 30 of the mounting plate 12. The inner edge 82 is positioned inward from the inner surface 32 of the mounting plate 12. Blade plate 22 is positioned rearward of the rear end 26 of the mounting plate and rearward of the rear surface 48 of the first pivot arm 16. In the shown embodiment, the bottom edge 74 of the blade plate 22 is substantially parallel and spaced apart from the length of the first pivot arm 16. Thus, when the first pivot arm is in its neutral position, the blade plate 22 is also in the neutral position to position the outer edge 80 of the blade plate 22 outside the plane 76 (or plane 78 when referring to the second drag scraper 10B).

Near the bottom edge 74 of the blade plate 22, there may be defined a plurality of apertures that extend through the thickness of the blade plate 22 from the forward surface 68 to the rear surface 70. These apertures retain screws or bolts that releasably connect a blade insert 84. The blade insert 84 extends fully along the length of the blade plate 22 from the outer edge 80 to the inner edge 82. The insert 84 may be formed from a polymer material. This polymer material used to define the blade insert or blade attachment 84 can be a sacrificial material defining a sacrificial surface that is configured to protect the metal defining bottom edge 74 and optionally wear down over time in response to continuous operation of the drag scraper 10 during the soil smoothing operation. Further, the blade insert 84 being sacrificial enables the screws or bolts to be removed and a new insert to be replaced when the insert material of blade insert 84 has worn down and exceeded its useful life.

With continued reference to insert 84, one exemplary embodiment uses high density ultra-high molecular weight polyethylene (HDUHMW-PE) as a hard nylon material to replace and protect the metal lower edge 74 on the blade 22. By utilizing the insert 84, the drag scraper 10 can enhance durability, reduce maintenance, and improve performance. HDUHMW-PE offers excellent wear resistance, low friction, and high impact strain, making it preferable for material applications that require long lasting and low maintenance wear surfaces. Although the insert 84 is identified as HDMW-PE, which is a thermoplastic polymer made from ethylene monomers, other substitutes could be possible. For example, an ultra-high molecular weight polyethylene (UHMW-PE) or a high-density polyethylene (HDPE) are other thermoplastic polymers that could be utilized. In another embodiment, tungsten carbide or hardox steel can be utilized to fabricate the insert 84 that is attached to the lower end of the blade plate 22.

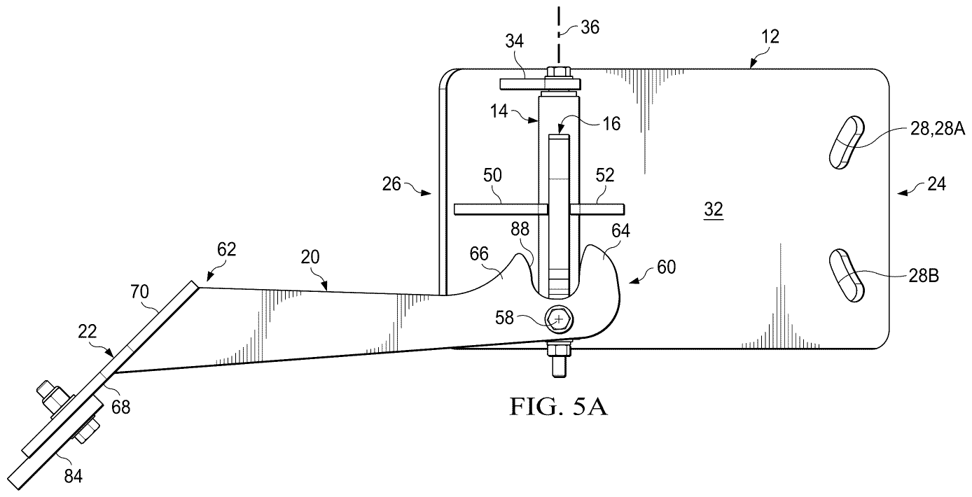

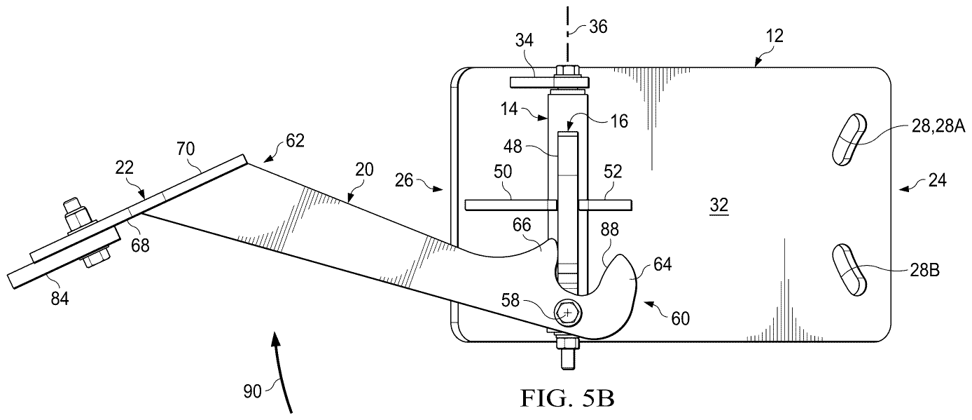

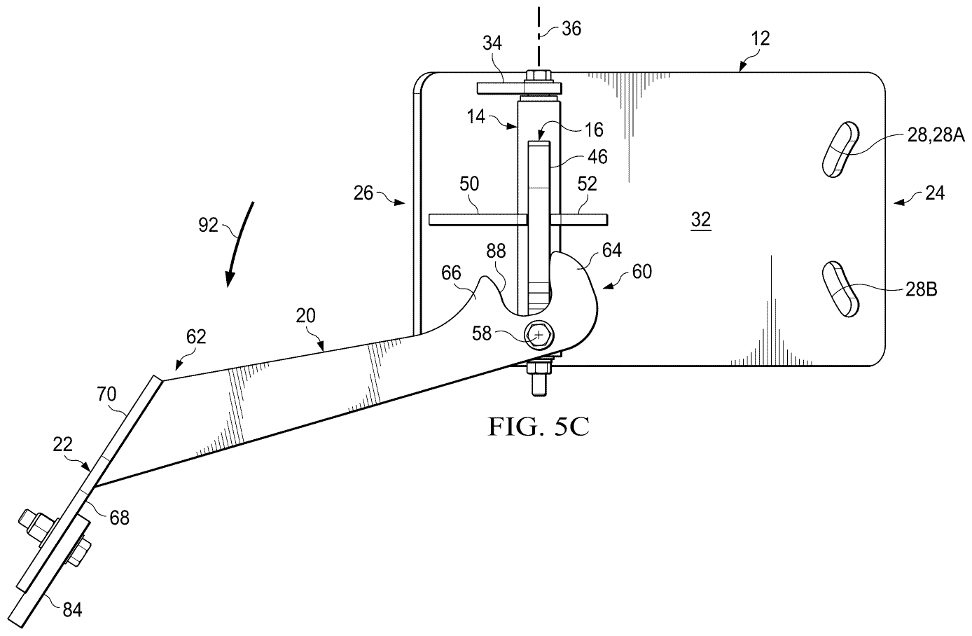

FIG. 5A depicts the neutral position of the second pivot arm 20 in which neither the third stop 64 nor the second stop 66 contacts the first pivot arm 16. In this neutral position, the blade plate 22 is oriented at an angle relative to horizontal ground. In the shown embodiment, the angle of the blade plate horizontal to the ground is approximately 45 degrees. However, other embodiments may position the angle of the blade plate relative to the ground in a range from about 30 degrees to about 60 degrees.

With continued reference to FIG. 5A-5C, it is seen that the second pivot arm 20 can pivot about the second pivot axis 58 between the neutral position and an upper position. The upper position depicted in FIG. 5B, which may also be considered a jounce position, is bounded when the fourth stop 66 contacts the rear surface 48 of the first pivot arm 16. The upward movement of the second pivot arm 20 and blade plate 22 from the neutral position to the jounce position is indicated by arrow 90. Movement in the direction of arrow 90 occurs when the scarper 10 is being pulled forward by the agricultural implement 100 and uneven soil or an object, such as a root or rock, contacts the blade insert 84 or the forward surface 68 of the blade plate 22. The rotational path of travel of the blade plate 22 about the second axis 58 from the neutral position to the jounce position is about 25 degrees bounded at the upper limit by the fourth stop 66. After the soil mound, peak, rock or other object has contacted the blade insert 84 or the forward surface 68 of the blade plate 22 to pivot the blade plate 22 and second pivot arm 20 to the upper position or jounce position, the second hinge 18 will enable the second pivot arm 20 to return to the neutral position as shown in FIG. 5A due to the free hanging mass or weight of the blade plate 22 and the second arm 20. This configuration enables the blade plate 22 to maintain a consistent level relative to ground. Stated otherwise, the blade plate 22 is controlled with two orthogonal hinges 14, 18 that are orientated in such a way to restrict the blade plate 22 movement to keep it level with the ground while still allowing it to move up or down in response to implement depth or object contact.

FIG. 5C depicts the movement of the second swing arm 20 in the lowered position or rebound position in which the lowered position or rebound position is bounded by the third stop 64 contacting the forward surface 46 of the first pivot arm 16. The rotational movement of the second pivot arm 20 to the lowered position or rebound position is indicated by arrow 92 and may occur when the blade plate 22 encounters a depression in the soil thereby causing the second pivot arm 20 to drop in order to gather more soil to effectively level the same. The rotational path of travel of the blade plate 22 about the second axis 58 from the neutral position to the rebound position is bounded at the lower limit by the third stop 64. As the soil is leveled the second pivot arm 20 returns to the neutral position of FIG. 5A as the agricultural implement is pulled forward.

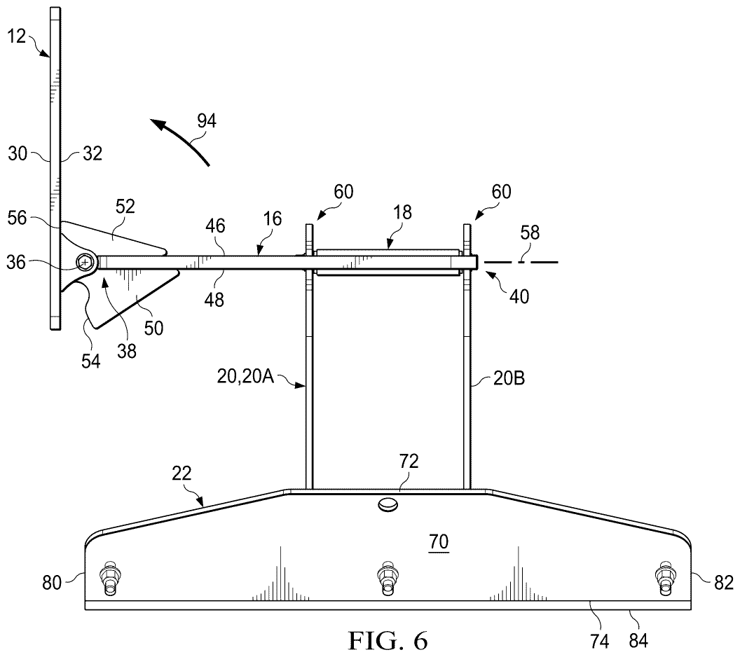

FIG. 6 depicts the operational rotation of the blade plate 22, the second pivot arm 20, and the first pivot arm 16 pivoting about the vertical first pivot axis 36 as indicated by arrow 94. The pivoting action in the direction of arrow 94 occurs when the blade plate 22, particularly the outer end 80 of the blade plate 22, contacts an object in the agricultural filed that is outward or outboard from the first side plane 76 of the agricultural implement 100. If the blade plate 22 contacts an object that is outward from the first plane 76, the force imparted on the blade plate will cause the first pivot arm 16 to rotate as indicated by arrow 94. The rotation will continue until the stop surface 56 on the second stop 52 engages the inner surface 32 of the mounting plate 12. The stop surface 56 on the second stop 52 bounds the path of travel of the first pivot arm 16. When the pivot arm 16 is rotated to this inward position, the angle 37 defined between plate 12 and first pivot arm 16 is approximately 90 degrees. Thus, it is shown that the first stop 50 and the second stop 52 bound the path of travel of the first pivot arm 16 about the axis 36 approximately 30 degrees (wherein angle 37 is approximately 120 degrees when the stop surface 54 on the first stop 50 engages the inner surface 32 of the mounting plate in the first position and wherein the angle 37 is about 90 degrees when the stop surface 56 on the second stop 52 contacts the inner surface 32 of the mounting plate 12 in the second position, thus 120 degrees less 90 degrees equates to an approximate 30 degree path of travel or bounded path of travel).

The implement 100 of the present disclosure may additionally include one or more sensors to sense or gather data pertaining to the surrounding environment or operation of the drag scraper 10. Some exemplary sensors capable of being electronically coupled with the drag scraper 10 (either directly connected to the drag scraper 10 or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; global positioning sensors sensing location, elevation, distance traveled, velocity/speed; audio sensors sensing local environmental sound levels, or voice detection; photo/light sensors sensing ambient light intensity, ambient, day/night, UV exposure; TV/IR sensors sensing light wavelength; temperature sensors sensing machine or motor temperature, ambient air temperature, and environmental temperature; radar sensors; lidar sensors; ultrasonic sensors; magnetic sensors, image sensors; and moisture sensors sensing surrounding moisture levels.

If sensors are utilized to gather data relating to the drag scraper 10 (or other components on implement 100), then sensed data may be evaluated and processed with artificial intelligence (AI). Analyzing data gathered from sensors using artificial intelligence involves the process of extracting meaningful insights and patterns from raw sensor data to produce refined and actionable results. Raw data is gathered from various sensors, for example those which have been identified herein or others, capturing relevant information based on the intended analysis. This data is then preprocessed to clean, organize, and structure it for effective analysis. Features that represent key characteristics or attributes of the data are extracted. These features serve as inputs for AI algorithms, encapsulating relevant information essential for the analysis. A suitable AI model, such as machine learning or deep learning (regardless of whether it is supervised or unsupervised), is chosen based on the nature of the data and the desired analysis outcome. The model is then trained using labeled or unlabeled data to learn the underlying patterns and relationships. The model is fine-tuned and optimized to enhance its performance and accuracy. This process involves adjusting parameters, architectures, and algorithms to achieve better results. The trained model is used to make predictions or inferences on new, unseen data. The model processes the extracted features and generates refined output based on the patterns it has learned during training. The results produced by the AI model are refined through post-processing techniques to ensure accuracy and relevance. These refined results are then interpreted to extract meaningful insights and derive actionable conclusions. Feedback from the refined results is used to improve the AI model iteratively. The process involves incorporating new data, adjusting the model, and enhancing the analysis based on real-world feedback and evolving requirements. Further, AI results can be used to alter the operation of the device, assembly, or system of the present disclosure based on feedback. For example, AI feedback can be used to improve the efficiency of the device, assembly, or system of the present disclosure by responding to predicted changes in the environment or predicted changes to the device, assembly, or system of the present disclosure more quickly than if only sensed by one or more of the sensors.

A sensor model may be employed, once trained, in the implement 100. In one embodiment, the drag scraper 10 can be used to teach a sensor model to predict sensor data for a specific scenario. Alternatively, sensor models can be utilized to generate the data to train the AI. The sensor model can be trained for any type of sensor, such as those types of sensors described above, and/or other sensor types. The elements described herein may be implemented as discrete or distributed components in any suitable combination and location. The various functions described herein may be conducted by hardware, firmware, and/or software. For example, a processor may perform various functions by executing instructions stored in memory.

The AI model and/or sensor model can include a deep neural network (DNN), convolutional neural network (CNN), another neural network (NN) or the like and can support generative learning. For example, the sensor model can include a generative adversarial network (GAN), a variational autoencoder (VAE), and/or another type of DNN, CNN, NN or machine learning model (e.g., natural language processing (NLP)). Generally, the sensor model can accept some encoded representation of a scene as input using any number of data structures and/or channels (e.g., concatenated vectors, matrices, tensors, images, etc.).

In a particular embodiment, the drag scraper 10 can use the sensors to acquire a representation of the real-world environment (e.g., a physical environment) at a given point in time. Data from these sensors may be used to generate a representation of a scene or scenario, which may then be used to teach a sensor model. For example, a representation of a scene can be derived from sensor data, properties of objects in the scene or surrounding environment such as positions or dimensions (e.g., soil levels), classification data identifying objects in the scene or surrounding environment, properties or classification data of components of the implement 100, or some combination thereof. Generally, the sensor model learns to predict sensor data from a representation of the scene, environment or operation of the drag scraper 10 or implement 100.

The sensor model architecture can be selected to fit the shape of the desired input and output data. Examples of architectures (e.g., DNNs) include, but are not limited to, perceptron, feed-forward, radial basis, deep feed-forward, recurrent, long/short term memory, gated recurrent unit, autoencoder, variational autoencoder, convolutional, deconvolutional, and generative adversarial. Some DNN architectures, such as a GAN, can include a convolutional neural network (CNN) that accepts and evaluates an input image and may include multiple input channels, which may be used to accept and evaluate multiple input images and/or input vectors.

The implement 100 may include wireless communication logic coupled to sensors on the drag scraper 10 or another component of implement 100. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

The system that receives and processes signals from the drag scraper or another component of implement 100 may differ from embodiment to embodiment. In one embodiment, alerts and signals from the implement 100 are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as a maintenance department. Thus, if a particular implement 100 creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of a component of drag scraper 10 being the described shape, that same component could have a different shape, such as semi-circular, triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Any flowchart and/or block diagrams in the Figures illustrate some exemplary architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. As another example, “at least one of: A, B, or B” is intended to cover A, B, C, A-B, A-C, B-C, and A-B-C, as well as any combination with multiple of the same item.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element or “another” element, that does not preclude there being more than one of the additional element or the another element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A drag scraper for connection with a rear end of an agricultural implement, wherein the drag scraper is configured to smooth soil as the agricultural implement is pulled, and the drag scraper comprises:
a first hinge defining a first pivot axis, wherein the first axis is oriented in a vertical direction;
a second hinge defining a second pivot axis, wherein the second axis is oriented in a horizontal direction;
a blade plate positioned rearward of the first hinge and the second hinge, wherein the blade pivots about the first axis in response to contact with an object located outward from a first side of the agricultural implement to which the drag scraper is mounted, and wherein the blade pivots about the second axis in response to contact with unlevel soil or in response to lowering of the agricultural implement to which the drag scraper is attached; wherein the first hinge and the second hinge each enable the blade plate to return to a neutral position after pivoting in response to contact with the object or unlevel soil.

2. The drag scraper of claim 1, further comprising:
a rebound position of the blade plate;
a jounce position of the blade plate;
wherein the blade plate pivots about the second pivot axis between the rebound and jounce positions based on surface contours of the soil or height of agricultural implement or upon contact with an object in the soil, wherein a bottom edge of the blade plate is parallel and maintains a consistent level relative to ground when pulled by the agricultural implement through or across soil.

3. The drag scraper of claim 1, further comprising:
a first pivot arm having a first end and a second end, wherein the first end of the first pivot arm is coupled to the first hinge and the second end of the first pivot arm is coupled to the second hinge.

4. The drag scraper of claim 3, further comprising:
a second pivot arm having a forward end and a rear end, wherein the forward end of the second pivot arm is coupled to the second hinge and the rear end of the second pivot arm is connected to the blade plate.

5. The drag scraper of claim 4, further comprising:
a first stop and a second stop at the first end of the first pivot arm, wherein the first stop and the second stop bound a rotational path of travel about the first pivot axis; and
a third stop and a fourth stop at the forward end of the second pivot arm, wherein the third stop and the fourth stop bound a rotational path of travel about the second pivot axis.

6. The drag scraper of claim 3, further comprising:
a length of the of the blade plate measured from an outer end to an inner end, wherein the length of the blade plate is greater than that of the first pivot arm.

7. The drag scraper of claim 1, further comprising:
an outer end of the blade plate and an inner end of the blade plate, wherein when the drag scraper is in a neutral position the outer end of the blade plate is positioned outward from a first side plane defined by an outermost side of the agricultural implement.

8. The drag scraper of claim 1, further comprising:
a forward surface and a rear surface of the blade plate;
wherein the forward surface of the blade plate is in a range from about 30 degrees to about 60 degrees relative to horizontal in the neutral position.

9. The drag scraper of claim 1, further comprising:
a first stop at an end of a first pivot arm;
a second stop at the end of the first pivot arm, wherein the first stop and the second stop bound a rotational path of travel about the first pivot axis;
wherein the rotational path of travel is bounded in a region of about 30 degrees about the first pivot axis.

10. The drag scraper of claim 1, further comprising:
a mounting plate for mounting the drag scraper to the agricultural implement, wherein the mounting plate has a forward end and a rear end;
wherein the first hinge is coupled the mounting plate near the rear end of the mounting plate;
a first pivot arm coupled to the first hinge and extending therefrom;
an angle defined between the first pivot arm and the mounting plate;
a neutral position of the first pivot arm and rotated position of the first pivot arm, wherein the first pivot arm moves from the neutral position to the rotated position in response to contact from an object as the agricultural implement and drag scraper are pulled forward;
wherein the angle is about 120 degrees in the neutral position and wherein the angle is about 90 degrees in the rotated position.

11. The drag scraper of claim 1, further comprising:
a mounting plate for mounting the drag scraper to the agricultural implement, wherein the mounting plate has a forward end and a rear end;
wherein the first hinge is coupled the mounting plate near the rear end of the mounting plate;
a first pivot arm coupled to the first hinge and extending therefrom;
wherein the second hinge is coupled to first pivot arm along a bottom edge thereof;
two second pivot arms coupled to the second hinge, wherein one of the second pivot arms is coupled to a first end of the second hinge and the other of the second pivot arms is coupled to a second end of the second hinge;
a rear end of each of the two second pivot arms that is coupled to a forward surface of the blade plate.

12. The drag scraper of claim 1, further comprising:
a first rotational action of the blade plate about the first axis that occurs within an about 30 degree bounded path travel, wherein the first rotational action is bounded between a first stop and a second stop;
a second rotational action of the blade plate about the second axis that occurs within an about 32 degree path of travel, wherein the second rotational action is bounded between a third stop and a fourth stop;
wherein the first axis is perpendicular to the second axis.

13. A drag scraper for connection with a rear end of an agricultural implement, wherein the drag scraper is configured to smooth soil as the agricultural implement is pulled, and the drag scraper comprising:
a mounting plate having a forward end and a rear end, wherein the mounting plate defines at least one aperture extending through the mounting plate to connect the mounting plate to the rear end of the agricultural implement, wherein the mounting plate has first major surface that faces outward relative to the agricultural implement and a second major surface that faces inward relative to the agricultural implement;
a first hinge connected to the second major surface of the mounting plate, wherein the first hinge defines a first pivot axis that is aligned in a vertical direction and located inward from the second major surface of the mounting plate;
a first pivot arm having a first end and a second end, wherein the first end of the first pivot arm is connected to the first hinge and the first pivot arm pivots about the first pivot axis, wherein a first stop and a second stop are connected to the first end of the first pivot arm, wherein the first stop and the second stop bound a rotational path of travel of the first pivot arm about the first pivot axis;
a second hinge connected to the first pivot arm near the second end of the first pivot arm, wherein the second hinge defines a second pivot axis that is aligned in a horizontal direction;
a second pivot arm having a forward end and a rear end, wherein the forward end of the second pivot arm is connected to the second hinge and the second pivot arm extends reward toward the second end and the second pivot arm pivots about the second pivot axis, wherein a third stop and a fourth stop are at the forward end of the second pivot arm, wherein the third stop and the fourth stop bound a rotational path of travel of the second pivot arm about the second pivot axis; and
a blade plate having a forward surface and a rear surface, and having a top end and bottom end, wherein the blade plate is rigidly connected to the rear end of the second pivot arm, wherein the bottom end of the blade plate smooths soil and pivots about at least one of the first pivot axis and the second pivot axis in response to interaction with the soil or other objects as the agricultural implement is pulled.

14. A method comprising:
coupling a drag scraper to a first side of an agricultural implement at a rear end thereof;
orienting a blade plate in a neutral position and positioning an outer end of the blade plate outward from a first side plane of the agricultural implement;
pulling the agricultural implement forward;
rotating the blade plate about a first pivot axis that is vertically aligned in response to making contact with an object located outward from the first side plane from the agricultural implement; and
leveling the soil behind the agricultural implement with the drag scraper.

15. The method of claim 14, further comprising:
rotating a first pivot arm about the first pivot axis from a neutral first position to a second position, wherein a first stop on the first pivot arm contacts an inner surface of a mounting plate coupled to the agricultural implement;
bounding rotation of the first pivot arm at the second position.

16. The method of claim 15, wherein bounding rotation of the first pivot arm is accomplished by contacting a second stop on the first pivot arm with the inner surface of the mounting plate.

17. The method of claim 14, further comprising:
rotating the blade plate about a second pivot axis that is horizontally aligned in response to making contact with unlevel soil or an object in the soil.

18. The method of claim 17, further comprising:
rotating a second pivot arm about the second pivot axis from the rebound position to a jounce position, wherein a third stop on the second pivot arm contacts a forward surface on the first pivot arm in the rebound position and fourth stop on the second pivot arm contacts a rear surface on the first pivot arm in the jounce position;
bounding rotation of the second pivot arm between the third stop and the fourth stop.
